(19) United States
(12) Patent Application Publication
(10) Pub. No.: US 2009/0029898 A1
(43) Pub. Date: Jan. 29, 2009

(54) Washing or Cleaning Composition Comprising Dye Transfer Inhibitor

(75) Inventors: Theodor Voelkel, Erkrath (DE); Bernhard Guckenbiehl, Cologne (DE); Christina Roeleke, Moenchengladbach (DE)

Correspondence Address: Ratner Prestia, Suite 301, 1235 Westlakes Drive, Berwyn, PA, 19312, US

(73) Assignee: Henkel AG & Co. KGaA, Duesseldorf (DE)

(21) Appl. No.: 12/183,855

(22) Filed: Jul. 31, 2008

Related U.S. Application Data
(63) Continuation of application No. PCT/EP2007/000062, filed on Jan. 5, 2007.

(30) Foreign Application Priority Data
Jan. 31, 2006 (DE) 10 2006 004 697.8

(51) Int. Cl. C11D 7/32

(52) U.S. Cl. 510/353

(57) ABSTRACT

Washing or cleaning compositions that contain a surfactant and a fatty alkyl dialkylhydroxyethylammonium salt as a dye transfer inhibitor, as well as processes for making the compositions and for washing or cleaning colored textile fabrics.

### CROSS REFERENCE TO RELATED APPLICATIONS

This application is a continuation under 35 U.S.C. §§ 120 and 365(c) of international application PCT/EP22007/000062, filed on Jan. 5, 2007. This application also claims priority under 35 U.S.C. § 119 of DE 10 2006 004 697.8, filed on Jan. 31, 2006.

### BACKGROUND OF THE INVENTION

The invention relates to a washing or cleaning composition comprising surfactant(s) as well as other conventional ingredients of washing or cleaning compositions, whereby the washing or cleaning composition contains a dye transfer inhibitor. The invention also relates to the use of the washing or cleaning composition and a method for production of same. In addition, the invention relates to a method for washing or cleaning dyed textile fabrics.

When washing dyed textiles, the dyestuff is partially released from the dyed textiles and transferred from the wash bath to other fabrics. For example, if white or light textiles are washed together with colored textiles, the white and/or light laundry becomes soiled/discolored with these dyestuffs. To prevent transfer of the released textile dyestuff from the wash bath onto the laundry material, so-called color cleaning compositions have been developed, containing polymeric dye transfer inhibitors. These are, for example, homopolymers and copolymers of vinylpyrrolidone and vinylimidazole, as disclosed in DE 2814287.

### DESCRIPTION OF THE INVENTION

The object of the invention is to provide a washing or cleaning composition which effectively suppresses the release of dyestuff and/or the transfer of dyestuff to other textiles during the washing and/or cleaning of dyed textiles.

This object is achieved by a washing or cleaning composition comprising surfactant(s) as well as other conventional ingredients of washing or cleaning compositions, whereby the composition comprises a fatty alkyl dialkyl-hydroxyethylammonium salt as a dye transfer inhibitor.

It has surprisingly been found that fatty alkyl dialkylhydroxyethyl-ammonium salts have a dye transfer inhibiting effect in washing or cleaning compositions.

In addition, it is preferable that the fatty alkyl dialkylhydroxyethyl-ammonium salt is a fatty alkyl dimethylhydroxyethylammonium salt, preferably a C₁₂-C₁₈ fatty alkyl dimethylhydroxyethylammonium salt. It is preferable in particular for the fatty alkyl dimethylhydroxyethylammonium salt to be C₁₂-C₁₄ fatty alkyl dimethylhydroxyethylammonium chloride.

These fatty alkyl dialkylhydroxyethylammonium salts are especially effective dye transfer inhibitors.

The amount of fatty alkyl dialkylhydroxyethylammonium salt is preferably between 0.001 and 10 wt % (percent by weight), more preferably between 0.1 and 5 wt % and in particular preferably between 0.5 and 2 wt %.

With these amounts of fatty alkyl dialkylhydroxyethylammonium salt, a good dye transfer inhibiting effect is observed, and the resulting washing or cleaning compositions are stable.

It is preferable for the washing or cleaning composition to contain a second dye transfer inhibitor.

The use of a fatty alkyl dialkylhydroxyethylammonium salt in combination with at least one second dye transfer inhibitor shows a definitely improved dye transfer inhibiting effect.

Preferably polyvinylpyrrolidones (PVP), polyvinylimidazoles (PVI), copolymers of vinylpyrrolidone and vinylimidazole (PVP/PVI), polyvinylpyridine N-oxides, poly-N-carboxymethyl-4-vinylpyridium chloride and mixtures thereof are used.

These dye transfer inhibitors are known and commercially available (co)polymers which can be incorporated well and stably into washing or cleaning compositions.

It is preferable for the washing or cleaning composition to contain anionic surfactants in amounts of less than 5 wt %.

Large amounts of anionic surfactants can reduce the efficacy of fatty alkyl dialkylhydroxyethylammonium salts in washing or cleaning compositions. It is therefore preferable to use only small amounts (less than 5 wt %) of anionic surfactants in the washing or cleaning compositions. The washing or cleaning composition in particular preferably does not contain any anionic surfactants.

It may be preferable in particular for the washing or cleaning composition to contain exclusively nonionic surfactants.

By using an exclusively nonionic surfactant system, a washing or cleaning composition that is particularly mild on textiles to be treated with it and/or skin coming in contact with the composition itself or with laundry washed with the composition is obtained. The latter is particularly advantageous, in particular with textiles (e.g., underwear, sheer lingerie) that comes in direct contact with the skin. Such textiles are often manufactured from sensitive materials and/or are dyed with intense dyestuffs. Since these textiles are usually also very expensive, the use of a mild washing or cleaning composition with effective dye transfer inhibition is advantageous in particular.

The invention also relates to the use of the inventive washing or cleaning composition for washing and/or cleaning dyed textile fabrics.

It has been found that the inventive washing or cleaning composition effectively suppresses the release of dyestuffs and/or the transfer of dyestuffs to another textile fabric during the washing and/or cleaning of dyed textile fabrics.

Furthermore, the invention also relates to the use of a fatty alkyl dialkyl-hydroxyethylammonium salt as a dye transfer inhibitor in a washing or cleaning composition.

It has been found that fatty alkyl dialkylhydroxyethylammonium salts may be used as effective dye transfer inhibitors in washing or cleaning compositions and, when using the washing or cleaning composition, the release of dyestuff and/or the transfer of dyestuff to other textiles during washing and/or cleaning of dyed textiles is/are effectively suppressed.

The invention also relates to a method for producing a washing or cleaning composition comprising surfactant(s), additional conventional ingredients of washing or cleaning compositions and a dye transfer inhibitor, whereby a fatty alkyl dialkylhydroxyethylammonium salt is added as a dye transfer inhibitor to the washing or cleaning composition.

In another aspect, the invention also relates to the use of a fatty alkyl dialkylhydroxyethylammonium salt as a dye transfer inhibitor in washing and/or cleaning dyed textiles.

Yet another aspect of the invention relates to a method for washing and/or cleaning dyed textile fabrics, whereby the transfer of dyestuff from dissolved dyestuffs to other textile fabrics is reduced or suppressed by addition of a fatty alkyl dialkylhydroxyethylammonium salt.

An inventive washing or cleaning composition contains a fatty alkyl dialkylhydroxyethylammonium salt as the dye transfer inhibitor.

The fatty alkyl dialkylhydroxyethylammonium salt is preferably a fatty alkyl dimethylhydroxyethylammonium salt and a C₁₂-C₁₈ fatty alkyl dimethyl-hydroxyethylammonium salt in particular, whereby a C₁₂-C₁₄ fatty alkyl dimethylhydroxyethylammonium salt is extremely preferred. As counterions, the salts may contain halide ions, methosulfate ions, methophosphate ions or phosphate ions as well as mixtures thereof. The counterion is preferably chloride.

An example of the commercially available fatty alkyl dimethylhydroxyethylammonium salt is Praepagen® HY (from Clariant), a C₁₂/C₁₄ fatty alkyl dimethylhydroxyethylammonium chloride.

The amount of fatty alkyl dialkylhydroxyethylammonium salt in the washing or cleaning composition may be between 0.001 and 10 wt %, based on the total composition. The amount of fatty alkyl dialkylhydroxyethylammonium salt is preferably between 0.1 and 5 wt %, and in particular preferably the amount of fatty alkyl dialkylhydroxyethylammonium salt is between 0.5 and 2 wt %.

In addition to the fatty alkyl dialkylhydroxyethylammonium salt, the washing or cleaning composition contains surfactant(s), whereby anionic, nonionic, zwitterionic and/or amphoteric surfactants may be used. Mixtures of anionic and nonionic surfactants are preferred. The total surfactant content of the liquid washing or cleaning composition is preferably less than 40 wt % and especially preferably less than 35 wt %, based on the total liquid washing composition.

As nonionic surfactants, preferably alkoxylated, advantageously ethoxylated, in particular primary alcohols with preferably 8 to 18 carbon atoms and an average of 1 to 12 mol ethylene oxide (EO) per mol alcohol are used, in which the alcohol radical may be linear or preferably methyl-branched in position 2 and/or may contain linear and methyl-branched radicals in mixture, such as they usually occur in oxo alcohol radicals. In particular, however, alcohol ethoxylates with linear radicals of alcohols of native origin with 12 to 18 carbon atoms, for example, from coconut alcohol, palm alcohol, tallow fatty alcohol or oleyl alcohol, and an average of 2 to 8 EO per mol alcohol are preferred. The preferred ethoxylated alcohols include, for example, C₁₂₋₁₄ alcohols with 3 EO, 4 EO or 7 EO, C₉₋₁₁ alcohol with 7 EO, C₁₃₋₁₅ alcohols with 3 EO, 5 EO, 7 EO or 8 EO, C₁₂₋₁₈ alcohols with 3 EO, 5 EO or 7 EO and mixtures thereof, such as mixtures of C₁₂₋₁₄ alcohol with 3 EO and C₁₂₋₁₇ alcohol with 7 EO. The stated degree of ethoxylation represents statistical averages, which may be an integer or a fraction for a specific product. Preferred alcohol ethoxylates have a narrow homolog distribution (narrow range ethoxylates, NRE). In addition to these nonionic surfactants, fatty alcohols with more than 12 EO may also be used. Examples of these include tallow fatty alcohol with 14 EO, 25 EO, 30 EO or 40 EO. Nonionic surfactants containing EO and PO groups together in the molecule may also be used according to this invention. Block copolymers with EO-PO block units and/or PO-EO block units may be used here, but EO-PO-EO copolymers and/or PO-EO-PO copolymers may also be used. Mixed alkoxylated nonionic surfactants in which EO and PO units are not distributed by blocks but instead have a random distribution may of course also be used. Such products are accessible by simultaneous action of ethylene oxide and propylene oxide on fatty alcohols.

Furthermore, alkyl glycosides of the general formula RO(G)ₓ, in which R denotes a primary linear or methyl-branched, in particular methyl-branched in position 2, aliphatic radical with 8 to 22 carbon atoms, preferably 12 to 18 carbon atoms, and G is the symbol standing for a glycose unit with 5 or 6 carbon atoms, preferably for glucose, may also be used as additional nonionic surfactants. The degree of oligomerization x, indicating the distribution of monoglycosides and oligoglycosides, is any number between 1 and 10; x is preferably 1.2 to 1.4. Alkyl glycosides are known mild surfactants.

Another class of nonionic surfactants that are preferably used and are used either as the exclusive nonionic surfactant or in combination with other nonionic surfactants include alkoxylated, preferably ethoxylated or ethoxylated and propoxylated fatty acid alkyl esters, preferably with 1 to 4 carbon atoms in the alkyl chain, in particular fatty acid methyl esters.

Nonionic surfactants of the amine oxide type, for example, N-cocoalkyl-N,N-dimethylamine oxide and N-tallow-N,N-dihydroxyethylamine oxide and fatty acid alkanolamides may also be suitable. The amount of these nonionic surfactants is preferably no more than the amount of ethoxylated fatty alcohols, in particular no more than half thereof.

Additional suitable surfactants include polyhydroxy fatty acid amides of formula (I)

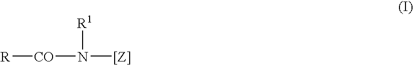

in which RCO denotes an aliphatic acyl radical with 6 to 22 carbon atoms, R¹ denotes hydrogen, an alkyl or hydroxyalkyl radical with 1 to 4 carbon atoms and [Z] denotes a linear or branched polyhydroxyalkyl radical with 3 to 10 carbon atoms and 3 to 10 hydroxyl groups. The polyhydroxy fatty acid amides are known substances which can usually be obtained by reductive amination of a reducing sugar with ammonia, an alkylamine or an alkanolamine and subsequent acylation with a fatty acid, a fatty acid alkyl ester or a fatty acid chloride.

The group of polyhydroxy fatty acid amides also includes compounds of formula (II)

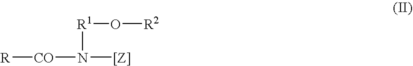

in which R denotes a linear or branched alkyl or alkenyl radical with 7 to 12 carbon atoms, R¹ denotes a linear, branched or cyclic alkyl radical or an aryl radical with 2 to 8 carbon atoms and R² denotes a linear, branched or cyclic alkyl radical or an aryl radical or an oxyalkyl radical with 1 to 8 carbon atoms, whereby C₁₋₄ alkyl radicals or phenyl radicals are preferred and [Z] denotes a linear polyhydroxyalkyl radical whose alkyl chain is substituted with at least two hydroxyl groups, or alkoxylated, preferably ethoxylated or propoxylated derivatives of this radical.

[Z] is preferably obtained by reductive amination of a sugar, for example, glucose, fructose, maltose, lactose, galactose, mannose or xylose. The N-alkoxy or N-aryloxy substituted compounds may then be converted to the desired polyhydroxy fatty acid amides by reaction with fatty acid methyl esters in the presence of an alkoxide as the catalyst.

The nonionic surfactant content in the washing or cleaning composition is preferably 5 to 30 wt %, especially 7 to 20 wt % and in particular 9 to 15 wt %, each based on the washing or cleaning composition.

In addition to the nonionic surfactants, the washing or cleaning composition may also contain anionic surfactants. As anionic surfactants, for example, those of the sulfonate and sulfate type are used. Surfactants of the sulfonate type that may be used preferably include C₉₋₁₃-alkylbenzenesulfonates, olefinsulfonates, i.e., mixtures of alkene- and hydroxyalkanesulfonates and disulfonates such as those obtained, for example, from C₁₂₋₁₈ monoolefins with terminal or internal double bonds by sulfonation with gaseous sulfur trioxide and then alkaline or acid hydrolysis of the sulfonation products. Also alkanesulfonates obtained from C₁₂₋₁₈ alkanes, e.g., by sulfochlorination or sulfoxidation with subsequent hydrolysis and/or neutralization are also suitable. Likewise, the esters of α-sulfo fatty acids (ester sulfonates), e.g., the α-sulfonated methyl esters of hydrogenated coconut, palm kernel or tallow fatty acids are also suitable.

Other suitable anionic surfactants include the sulfated fatty acid glycerol esters. Fatty acid glycerol esters include the mono-, di- and triesters as well as mixtures thereof, such as those obtained in production by esterification of a monoglycerol with 1 to 3 mol fatty acid or in ester exchange of triglycerides with 0.3 to 2 mol glycerol. Preferred sulfated fatty acid glycerol esters are the sulfation products of saturated fatty acids with 6 to 22 carbon atoms, for example, caproic acid, caprylic acid, capric acid, myristic acid, lauric acid, palmitic acid, stearic acid or behenic acid.

As alk(en)yl sulfates, the alkali salts and in particular the sodium salts of sulfuric acid hemiesters of C₁₂-C₁₈ fatty alcohols, e.g., from coconut fatty alcohol, tallow fatty alcohol, lauryl alcohol, myristyl alcohol, cetyl alcohol or stearyl alcohol or the C₁₀-C₂₀ oxo alcohols and the hemiesters of secondary alcohols of these chain lengths are preferred. Also preferred are the alk(en)yl sulfates of the aforementioned chain length, which contain a synthetic linear alkyl radical produced on a petrochemical basis and have a degradation behavior similar to that of adequate compounds based on raw materials from fat chemistry. The C₁₂-C₁₆ alkyl sulfates and C₁₂-C₁₅ alkyl sulfates as well as C₁₄-C₁₅ alkyl sulfates are preferred from a washing technical interest. Also 2,3-alkyl sulfates, which are available as commercial products of Shell Oil Company under the brand name DAN® are suitable anionic surfactants.

The sulfuric acid monoesters of linear or branched C₇₋₂₁ alcohols ethoxylated with 1 to 6 mol ethylene oxide as well as 2-methyl-branched C₉₋₁₁ alcohols with an average of 3.5 mol ethylene oxide (EO) or C₁₂₋₁₈ fatty alcohols with 1 to 4 EO are also suitable. They are used in cleaning compositions only in relative small amounts, e.g., in amounts of 1 to 5 wt %, because of their high sudsing behavior.

Other suitable anionic surfactants also include the salts of alkyl sulfosuccinate acid, which are also referred to as sulfosuccinates or as sulfosuccinic acid esters, and the monoesters and/or diesters of sulfosuccinic acid with alcohols, preferably fatty alcohols and in particular ethoxylated fatty alcohols. Preferred sulfosuccinates contain C₈₋₁₈ fatty alcohol radicals or mixtures thereof. In particular preferred sulfosuccinates contain a fatty alcohol radical which is derived from ethoxylated fatty alcohols, which are nonionic surfactants when considered per se (see description below). Again, sulfosuccinates whose fatty alcohol radicals are derived from ethoxylated fatty alcohols having a narrow homolog distribution are especially preferred. It is likewise also possible to use alk(en)ylsuccinic acid with preferably 8 to 18 carbon atoms in the alk(en)yl chain or the salts thereof.

In particular preferred anionic surfactants are soaps. Saturated and unsaturated fatty acid soaps such as the salts of lauric acid, myristic acid, palmitic acid, stearic acid, (hydrogenated) erucaic acid and behenic acid as well as in particular soap mixtures derived from natural fatty acids, for example, coconut, palm kernel, olive oil or tallow fatty acids are also suitable.

The anionic surfactants including the soaps may be in the form of their sodium, potassium or ammonium salts as well as soluble salts of organic bases such as mono-, di- or triethanolamine. The anionic surfactants are preferably in the form of their sodium or potassium salts, in particular in the form of the sodium salts.

The anionic surfactant content of a washing or cleaning composition may be 0.1 to 30 wt %, based on the total washing or cleaning composition. However, it is preferable for the amount of anionic surfactants to be relatively low to minimize interactions of the anionic surfactants with the dye transfer inhibitor, which reduce the effect thereof. It is therefore preferable for the washing or cleaning composition to contain anionic surfactants in amounts of up to 5 wt %. The washing or cleaning composition most especially preferably does not contain any anionic surfactants.

In the present invention, it may be extremely preferable for aesthetic reasons and/or stability reasons, among others, for the washing or cleaning composition to contain exclusively nonionic surfactants. This also applies to mild washing or cleaning compositions.

In addition to the dye transfer inhibitor and the surfactant(s), the washing or cleaning composition may also contain other ingredients which further improve the technical applications properties and/or aesthetic washing or cleaning composition. Within the context of the present invention, the washing or cleaning composition preferably additionally contains one or more substances from the group of builders, enzymes, electrolytes, nonaqueous solvents, pH adjusting agents, perfumes, perfume vehicles, fluorescent agents, dyestuffs, hydrotopes, foam inhibitors, silicone oils, anti-redeposition agents, graying inhibitors, shrinkage preventers, antiwrinkle agents, other dye transfer inhibitors, antimicrobial active ingredients, germicides, fungicides, antioxidants, preservatives, corrosion inhibitors, antistatics, bitter agents, ironing aids, phobizing and impregnating agents, swelling and nonslip agents, neutral filler salts, softening components and UV absorbers.

It is preferred in particular for the washing or cleaning composition to contain a second dye transfer inhibitor, preferably containing nitrogen. It is preferable in particular for the second dye transfer inhibitor to be a polymer or copolymer of cyclic amines, for example, vinylpyrrolidone and/or vinylimidazole. Polymers suitable as dye transfer inhibitors include polyvinylpyrrolidone (PVP), polyvinylimidazole (PVI), copolymers of vinylpyrrolidone and vinylimidazole (PVP/PVI), polyvi nylpyridine N-oxide, poly-N-carboxymethyl-4-vinylpyridium chloride and mixtures thereof. Polyvinylpyrrolidone (PVP), polyvinylimidazole (PVI) or copolymers of vinylpyrrolidone and vinylimidazole (PVP/PVI) are particularly preferably used as the second dye transfer inhibitor.

The polyvinylpyrrolidones (PVP) that are used preferably have an average molecular weight of 2500 to 400,000 and are available commercially from ISP Chemicals as PVP K 15, PVP K 30, PVP K 60 or PVP K 90 or are available from BASF as Sokalan® HP 50 or Sokalan® HP 53.

The copolymers of vinylpyrrolidone and vinylimidazole (PVP/PVI) that are used preferably have a molecular weight in the range of 5000 to 100,000. A PVP/PVI copolymer is available commercially from BASF, for example, with the brand name Sokalan® HP 56.

The amount of second dye transfer inhibitor, if present, based on the total amount of washing or cleaning composition is preferably from 0.01 to 2 wt %, preferably from 0.05 to 1 wt % and more preferably from 0.1 to 0.5 wt %.

As builders that may be present in the washing or cleaning composition, silicates, aluminosilicates (in particular zeolites), carbonates, salts of organic di carboxylic acids and polycarboxylic acids as well as mixtures of these substances may be mentioned.

Suitable crystalline laminar sodium silicates have the general formula NaMSiₓO₂ₓ₊₁.H₂O, where M denotes sodium or hydrogen, x is a number from 1.9 to 4, and y is a number from 0 to 20, and preferred values for x are 2, 3 or 4. Preferred crystalline laminar silicates of the given formula are those in which M stands for sodium and x assumes the values 2 or 3. In particular, both 1- and δ-sodium disilicates Na₂Si₂O₅.yH₂O are preferred.

Amorphous sodium silicates with a module Na₂O:SiO₂ of 1:2 to 1:3.3, preferably from 1:2 to 1:2.8 and in particular from 1:2 to 1:2.6, which have delayed dissolving and secondary washing properties, may also be used. The delayed dissolving with respect to traditional amorphous sodium silicates can be achieved in various ways, for example, by surface treatment, compounding, compacting/compressing or by overdrying. Within the context of this invention, the term “amorphous” is also understood to mean “amorphous to X-rays.” This means that these silicates do not supply sharp X-ray reflexes in X-ray diffraction experiments such as those typical of crystalline substances, but instead they have one or more peaks of scattered X-ray radiation having a width of several degree units of the diffraction angle. However, it can even lead to particularly good builder properties if the silicate particles yield blurred or even sharp diffraction peaks in electron diffraction experiments. This is to be interpreted as meaning that the products have microcrystalline regions of the size 10 to a few hundred nm, with values of up to max. 50 nm and in particular up to max. 20 nm being preferred. Compressed/compacted amorphous silicates, compounded amorphous silicates and overdried X-ray-amorphous silicates are preferred in particular.

The fine crystalline synthetic zeolite containing bound water as used here is preferably zeolite A and/or P. Zeolite MAP® (commercial product of the company Crosfield) is particularly preferred as zeolite P. However, zeolite X as well as mixtures of A, X, and/or P are also suitable. For example, a co-crystal product of zeolite X and zeolite A (approx. 80 wt % zeolite X) which is distributed by the company SASOL under the brand name VEGOBOND AX® and can be described by the formula

nNa₂O.(1−n)K₂O.Al₂O₃.(2-2.5)SiO₂.(3.5-5.5)H₂On=0.90-1.0

is also available commercially and is preferably used within the context of the present invention. This zeolite may be used as a spray-dried powder or even as an undried stabilized suspension that is still moist from production. For the case when the zeolite is used in the form of a suspension, it may contain small amounts of nonionic surfactants as stabilizers, e.g., 1 to 3 wt %, based on zeolite, of ethoxylated C₁₂-C₁₈ fatty alcohols with 2 to 5 ethylene oxide groups, C₁₂-C₁₄ fatty alcohols with 2 to 5 ethylene oxide groups or ethoxylated isotridecanols. Suitable zeolites have an average particle size of less than 10 μm (volume distribution; measurement method: Coulter counter) and preferably contain 18 to 22 wt %, in particular 20 to 22 wt % bound water.

Use of the phosphates, which are known in general, as builder substances is of course also possible if such a use should not be avoided for ecological reasons. The sodium slats of orthophosphates, pyrophosphates and in particular tripolyphosphates are suitable in particular.

Organic builders which may be present in the washing or cleaning composition include, for example, the polycarboxylic acids that may be used in the form of their sodium salts, where polycarboxylic acids are understood to include such carboxylic acids which have more than one acid function. For example, these include citric acid, adipic acid, succinic acid, glutaric acid, malic acid, tartaric acid, maleic acid, fumaric acid, saccharic acids, aminocarboxylic acids, nitrilotriacetic acid (NTA) and the derivatives and mixtures thereof. Preferred salts include the salts of polycarboxylic acids such as citric acid, adipic acid, succinic acid, glutaric acid, tartaric acid, saccharic acids and mixtures thereof.

The acids per se may also be used. In addition to their builder effect, the acids typically also have the property of an acidifying component and thus also serve to adjust a lower and milder pH of the washing or cleaning compositions. In particular citric acid, succinic acid, glutaric acid, adipic acid, gluconic acid and any mixtures thereof may be mentioned here. Other acidifying agents that may be used include known pH regulators such as sodium bicarbonate and sodium bisulfate.

In addition, polymeric carboxylates are suitable as builders. These include, for example, the alkali metal salts of polyacrylic acid or polymethacrylic acid, e.g., those with a relative molecular weight of 500 to 70,000 g/mol.

In the sense of this document, the molecular weights given for polymeric polycarboxylates are weight-average molecular weights M_{w} of the respective acid form, which were determined fundamentally by means of gel permeation chromatography (GPC) using a UV detector. The measurement was performed against an external polyacrylic acid standard, which supplies realistic molecular weight values because it is structurally related to the polymers investigated. These values differ significantly from the molecular weight values based on polystyrenesulfonic acids as the standard. The molecular weights measured against polystyrenesulfonic acids are usually much higher than the molecular weights given in this document.

Suitable polymers include in particular polyacrylates, which preferably have a molecular weight of 2000 to 20,000 g/mol. Because of their superior solubility, the short chain polyacrylates having molecular weights of 2000 to 10,000 g/mol and particularly preferably from 3000 to 5000 g/mol may in turn be preferred from this group.

Suitable polymers may also comprise substances consisting partially or completely of units of vinyl alcohol or derivatives thereof.

In addition, copolymeric polycarboxylates, in particular those of acrylic acid with methacrylic acid and acrylic acid or methacrylic acid with maleic acid are also suitable. Copolymers of acrylic acid with maleic acid containing 50 to 90 wt % acrylic acid and 50 to 10 wt % maleic acid have proven to be particularly suitable. Their relative molecular weight, based on free acids, generally amounts to 2000 to 70,000 g/mol, preferably 20,000 to 50,000 g/mol and in particular 30,000 to 40,000 g/mol. The (co)polymeric polycarboxylates may be used either as an aqueous solution or preferably as a powder.

To improve the water solubility, the polymers may also contain allylsulfonic acids such as allyloxybenzenesulfonic acid and methallylsulfonic acid as monomer.

Biodegradable polymers of more than two different monomer units, for example, those containing salts of acrylic acid and maleic acid as well as vinyl alcohol and/or vinyl alcohol derivatives as monomers or salts of acrylic acid and 2-alkylallylsulfonic acid as well as sugar derivative as monomers are preferred in particular.

Other preferred copolymers include those having preferably acrolein and acrylic acid/acrylic acid salts and/or acrolein and vinyl acetate as monomers.

Likewise, polymeric aminodicarboxylic acids, their salts or their precursor substances may also be mentioned as additional preferred builders. Particularly preferred are polyaspartic acid and/or the salts and derivatives thereof, which also have a bleach stabilizing effect in addition to builder properties.

Other suitable builders include polyacetals, which may be obtained by reacting dialdehydes with polyolcarboxylic acids having 5 to 7 carbon atoms and at least three hydroxyl groups. Preferred polyacetals are obtained from dialdehydes such as glyoxal, glutaraldehyde, terephthalaldehyde as well as mixtures thereof and from polyolcarboxylic acids such as gluconic acid and/or glucoheptonic acid.

Other suitable organic builders include dextrins, for example, oligomers and/or polymers of carbohydrates that can be obtained by partial hydrolysis of starches. The hydrolysis may be performed by conventional methods, for example, acid-catalyzed or enzyme-catalyzed methods. These are preferably hydrolysis products with average molecular weights in the range of 400 to 500,000 g/mol. A polysaccharide with a dextrose equivalent (DE) in the range of 0.5 to 40, in particular 2 to 30, is preferred, where DE is a conventional measure for the reducing effect of a polysaccharide in comparison with dextrose, which has a DE of 100. Maltodextrins with a DE between 3 and 20 and dry glucose syrups with a DE between 20 and 37 as well as so-called yellow dextrins and white dextrins with higher molecular weights in the range of 2000 to 30,000 g/mol may be used.

The oxidized derivatives of such dextrins are their reaction products with oxidizing agents that are capable of oxidizing at least one alcohol function of the saccharide ring to the carboxylic acid function. An oxidized oligosaccharide is likewise suitable. A product oxidized at the C₆ of the saccharide ring may be particularly advantageous.

Oxydisuccinates and other derivatives of disuccinates, preferably ethylenediaminedisuccinate, are also further suitable builders. Ethylenediamine-N,N′-disuccinate (EDDS) is used here, preferably in the form of its sodium or magnesium salts. In this context, glycerol disuccinates and glycerol trisuccinates are also preferred.

Other usable organic builders include, for example, acetylated hydroxycarboxylic acids and/or the salts thereof, which may also be present in lactone form, if necessary, and have at least four carbon atoms and at least one hydroxyl group plus max. two acid groups.

It may also be preferable for the washing or cleaning composition to be a softening washing or cleaning composition (“2 in 1”). To this end, the washing or cleaning composition also contains a softening component in addition to the dye transfer inhibitor and the surfactants.

The softening component includes, for example, quaternary ammonium compounds, such as monoalk(en)yltrimethylammonium compounds, dialky(en)yldimethylammonium compounds, mono-, di- or triesters of fatty acids with alkanolamines.

Suitable examples of quaternary ammonium compounds are represented in formulas (III) and (IV), for example:

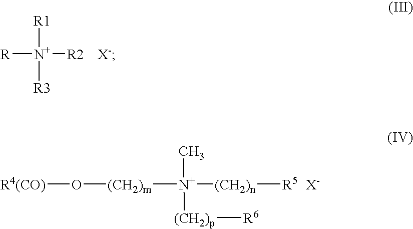

whereby R in (III) stands for an acyclic alkyl radical with 12 to 24 carbon atoms, R¹ stands for a saturated C₁-C₄ alkyl or hydroxyalkyl radical, R² and R³ are either the same as R or R¹ or stand for an aromatic radical. X⁻ stands either for a halide ion, a methosulfate ion, a methophosphate ion or a phosphate ion as well as mixtures thereof. Examples of cationic compounds of formula (III) include monotallow trimethylammonium chloride, monostearyltrimethyl-ammonium chloride, didecyldimethylammonium chloride, ditallow dimethyl-ammonium chloride or dihexadecylammonium chloride.

Compounds of formulas (IV), (V) and (VI) are so-called ester quats. Ester quats are characterized by an excellent biodegradability. In formula (IV), R⁴ stands for an aliphatic alk(en)yl radical with 12 to 22 carbon atoms with 0, 1, 2 or 3 double bonds and/or with substituents, if necessary; R⁵ stands for H, OH or O(CO)R⁷, R⁶ stands, independently of R⁵, for H, OH or O(CO)R⁸, where R⁷ and R⁸, independently of one another, each stand for an aliphatic alk(en)yl radical with 12 to 22 carbon atoms with 0, 1, 2 or 3 double bonds; m, n and p may each have a value of 1, 2 or 3, independently of one another. X⁻ may be either a halide ion, a methosulfate ion, a methophosphate ion or a phosphate ion as well as mixtures of these anions. Compounds in which R⁵ denotes the O(CO)R⁷ group are preferred. Compounds in which R⁵ denotes the O(CO)R⁷ group and R⁴ and R⁷ denote alk(en)yl radicals with 16 to 18 carbon atoms are particularly preferred. Compounds in which R⁶ also stands for OH are preferred in particular. Examples of compounds of formula (IV) include methyl-N-(2-hydroxyethyl)-N,N-di(tallow acyloxyethyl)ammonium methosulfate, bis(palmitoyloxyethyl)hydroxyethylmethylammonium methosulfate, 1,2-bis-(tallow acyloxy)-3-trimethylammoniumpropane chloride or methyl-N,N-bis-(stearoyloxyethyl)-N-(2-hydroxyethyl)ammonium methosulfate.

If quaternated compounds of formula (IV) which have unsaturated alkyl chains are used, the preferred acyl groups are those whose corresponding fatty acids have an iodine value between 1 and 100, preferably between 5 and 80, more preferably between 10 and 60 and in particular between 15 and 45 and which have a cis/trans-isomer ratio (in wt %) of greater than 30:70, preferably greater than 50:50 and in particular equal to or greater to 60:40. Conventional commercial examples include the methylhydroxyalkyldialkoyloxyalkyl-ammonium methosulfates distributed by Stepan under the brand name Stepantex® or the products from Cognis known as Dehyquart®, the products from Degussa known as Rewoquat® and/or the products from Kao known as Tetranyl®. Other preferred compounds include the diester quats of formula (V) available under the names Rewoquat® W 222 LM and/or CR 3099.

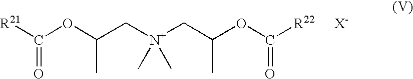

R²¹ and R²² independently of one another each stand for an aliphatic radical with 12 to 22 carbon atoms with 0, 1, 2 or 3 double bonds.

Instead of the ester group O(CO)R, where R stands for a long-chain alk(en)yl radical, softening compounds having the following groups may be used: RO(CO), N(CO)R or RN(CO), whereby of these groups N(CO)R groups are preferred.

In addition to the quaternary compounds described above, other compounds may also be used as softening components, such as quaternary imidazolinium compound of formula (VI)

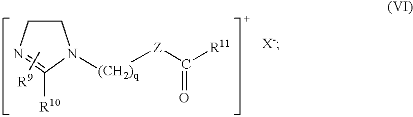

where R⁹ stands for H or a saturated alkyl radical with 1 to 4 carbon atoms, R¹⁰ and R¹¹ independently of one another each stand for an aliphatic, saturated or unsaturated alkyl radical with 12 to 18 carbon atoms, R¹⁰ alternatively may also stand for O(CO)R²⁰, whereby R²⁰ denotes an aliphatic, saturated or unsaturated alkyl radical with 12 to 18 carbon atoms and Z denotes an NH group or oxygen and X⁻ is an anion; q may assume integral values between 1 and 4.

Additional particularly preferred softening compounds are described by formula (VII)

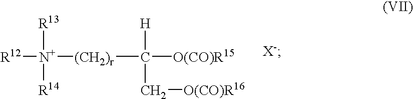

where R¹², R¹³ and R¹⁴ independently of one another stand for a C₁₋₄ alkyl, alkenyl or hydroxyalkyl group, R¹⁵ and R¹⁶ each selected independently represents a C₈₋₂₈ alkyl group, X⁻ is an anion and r is a number between 0 and 5. A preferred example of a cationic anti-redeposition aid according to formula (VII) is 2,3-bis(tallow acyloxy)-3-trimethylammoniumpropane chloride.

Additional softening components that may be used according to this invention are quaternated protein hydrolysates or protonated amines.

In addition, cationic polymers are also suitable softening components. The suitable cationic polymers include the polyquaternium polymers such as those [described] in the CTFA Cosmetic Ingredient Dictionary (The Cosmetic, Toiletry and Fragrance [Association], Inc., 1997), in particular the polyquaternium-6, polyquaternium-7, polyquaternium-10 polymers also known as merquats (Polymer JR, LR and KG series from Amerchol), polyquaternium-4 copolymers such as graft copolymers with a cellulose structure and quaternary ammonium groups bound by allyidimethylammonium chloride, cationic cellulose derivatives such as cationic guar such as guar hydroxypropyltriammonium chloride and similar quaternated guar derivatives (e.g., Cosmedia guar from Cognis or the Jaguar series from Rhodia), cationic quaternary sugar derivatives (cationic alkylpolyglucosides), e.g., the commercial product Glucquat® 100, according to CTFA nomenclature a “lauryl methyl gluceth-10 hydroxypropyldimonium chloride,” copolymers of PVP and dimethyl aminomethacrylate, copolymers of vinylimidazole and vinylpyrrolidone, aminosilicone polymers and copolymers.

Polyquaternated polymers (e.g., Luviquat® Care from BASF) and cationic biopolymers based on chitin and their derivatives, e.g., the polymer available under the brand name Chitosan® (manufacturer Cognis) may also be used.

Some of the cationic polymers mentioned additionally have skin care and/or textile care properties.

Compounds of formula (VIII) may also be used

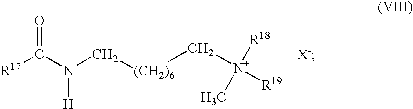

R¹⁷ may be an aliphatic alk(en)yl radical with 12 to 22 carbon atoms with 0, 1, 2 or 3 double bonds; s may assume values between 0 and 5. R¹⁸ and R¹⁹ independently of one another each stand for H, C₁₋₄ alkyl or hydroxyalkyl and X⁻ is an anion.

Other suitable softening components include protonated or quaternated polyamines.

Alternatively, the washing or cleaning composition may also contain a textile softening clay such as bentonite as a softening component.

Especially preferred softening components include alkylated quaternary ammonium compounds, of which at least one alkyl chain is interrupted by an ester group and/or an amido group. N-Methyl-N-(2-hydroxyethyl)-N,N-(ditallow acyloxyethyl)ammonium methosulfate or bis(palmitoyloxy-ethyl)hydroxyethylmethylam monium methosulfate are especially preferred.

The washing or cleaning composition may contain a thickener. The thickener may be, for example, a polyacrylate thickener, xanthan gum, gellan gum, guar bean powder, alginate, carrageenan, carboxymethylcellulose, bentonite, wellan gum, carob bean powder, agar, gum tragacanth, gum arabic, pectins, polyoses, starch, dextrins, gelatins and casein. However, modified natural substances such as modified starches and celluloses may also be used as thickeners; examples to be mentioned here include carboxymethylcellulose and other cellulose ethers, hydroxyethyl cellulose and hydroxypropyl cellulose as well as kernel meal ethers.

The polyacrylic and polymethacrylic thickeners include, for example, for the high-molecular homopolymers of acrylic acid crosslinked with a polyalkenyl polyether, in particular an allyl ether of sucrose, pentaerythritol or propylene (INCI terminology according to “International Dictionary of Cosmetic Ingredients” of the Cosmetic, Toiletry and Fragrance Association (CTFA): carbomer) which are also known as carboxyvinyl polymers. Such polyacrylic acid are available from 3V Sigma, among others, under the brand names Polygel®, e.g., Polygel DA, and from B.F. Goodrich under the brand name Carbopol®, e.g., Carbopol 940 (molecular weight approx. 4,000,000), Carbopol 941 (molecular weight approx. 1,250,000) or Carbopol 934 (molecular weight approx. 3,000,000). In addition, the following acrylic acid copolymers also fall under this: (i) copolymers of two or more monomers from the group of acrylic acid, methacrylic acid and their simple esters, preferably formed with C₁₋₄ alkanols (INCI acrylates copolymer), including the copolymers of methacrylic acid, butyl acrylate and methyl methacrylate (CAS designation according to Chemical Abstracts Service: 25035-69-2) or of butyl acrylate and methyl methacrylate (CAS 25852-37-3) and available from Rohm & Haas, for example, under the brand names Aculyn® and Acusol® as well as from the company Degussa (Goldschmidt) under the brand name Tego® polymer, the anionic nonassociative polymers Aculyn 22, Aculyn 28, Aculyn 33 (crosslinked), Acusol 810, Acusol 820, Acusol 823 and Acusol 830 (CAS 25852-37-3); (ii) crosslinked high-molecular acrylic acid copolymers, including the copolymers of C₁₀₋₃₀ alkyl acrylates crosslinked with an allyl ether of sucrose or pentaerythritol, and their simple esters, preferably formed with C₁₋₄ alkanols (INCI acrylates/C₁₀₋₃₀ alkyl acrylate crosspolymer) and available, e.g., from the company B.F. Goodrich under the brand name Carbopol®, e.g., hydrophobized Carbopol ETD 2623 and Carbopol 1382 (INCI acrylates/C₁₀₋₃₀ alkyl acrylate crosspolymer) as well as Carbopol Aqua 30 (formerly Carbopol EX 473).

Another preferred polymer thickener to be used here is xanthan gum, a microbial anionic heteropolysaccharide produced by Xanthomonas campestris and a few other species under aerobic conditions and having a molecular weight of 2 to 15 million daltons. Xanthan is formed from a chain with β-1-4-bound glucose (cellulose) with side chains. The structure of the subgroups consists of glucose, mannose, glucuronic acid, acetate and pyruvate, where the number of pyruvate units determines the viscosity of the xanthan gum.

A fatty alcohol may also be used as a thickener. Fatty alcohols may be branched or unbranched or of native origin or petrochemical origin. Preferred fatty alcohols have a C chain length of 10 to 20 carbon atoms, preferably 12 to 18 carbon atoms. Mixtures of different carbon chain lengths such as tallow fatty alcohol or coconut fatty alcohol are preferably also used. Examples include Lorol® special (C₁₂₋₁₄ ROH) or Lorol® technical grade (C₁₂₋₁₈ ROH) (both from Cognis).

The washing or cleaning composition may contain 0.01 to 3 wt % and preferably 0.1 to 1 wt % thickener. The amount of thickener used depends on the type of thickener and the desired degree of thickening.

The washing or cleaning composition may contain enzymes. Enzymes that may be mentioned include those in particular from the classes of hydrolases such as proteases, esterases, lipases and/or lipolytically active enzymes, amylases, cellulases and/or other glycosylhydrolases, hemicellulase, cutinases, β-glucanases, oxidases, peroxidases, perhydrolases and/or laccases and mixtures of the aforementioned enzymes. All these hydrolases contribute toward removal of spots such as spots containing protein, fat or starch and removal of graying in the laundry. Cellulases and other glycosylhydrolases may also contribute toward removal of pilling and microfibrils for maintaining color and for increasing the softness of the textile. For bleaching and/or for inhibiting dye transfer, oxyreductases may also be used. Enzymatic active ingredients obtained from bacterial strains or fungi such as Bacillus subtilis, Bacillus licheniformis, Streptomyces griseus and Humicola insolens are particularly suitable. Proteases of the subtilisin type and in particular proteases obtained from Bacillus lentus are preferably used. Enzyme mixtures, e.g., of protease and amylase or protease and lipase and/or lipolytically active enzymes or protease and cellulase or from cellulase and lipase and/or lipolytically active enzymes or protease, amylase and lipase and/or lipolytically active enzymes or protease, lipase and/or lipolytically active enzymes and cellulase, but in particular protease and/or lipase-containing mixtures and/or mixtures with lipolytically active enzymes are of particular interest. Examples of such lipolytically active enzymes include the known cutinases. Peroxidases or oxidases have also proven suitable in some cases. The suitable amylases include in particular α-amylases, isoamylases, pullulanases and pectinases. Preferably cellobiohydrolases, endoglucanases and 1-glucosidases, which are also known as cellobiases, and/or mixtures thereof are preferably used as cellulases. The desired activities can be adjusted through targeted mixtures of the cellulases because the different types of cellulase differ in their CMCase and avicelase activities.

The enzymes may be encapsulated or adsorbed on carrier substances to protect them from premature decomposition. The amount of the enzymes, the enzyme liquid formulation(s) or the enzyme granules in a washing or cleaning composition may be, for example, approx. 0.01 to 5 wt %, preferably 0.12 to approx. 2.5 wt %.

A wide number of different salts may be used as electrolytes from the group of inorganic salts. Preferred cations include the alkali and alkaline earth metals, preferred anions being the halides and sulfates. From a technical manufacturing standpoint, use of NaCl or MgCl₂ in the textile treatment agents is preferred. The amount of electrolytes in the washing or cleaning composition is usually 0.1 to 5 wt %.

Nonaqueous solvents that may be added to the washing or cleaning composition originate, for example, from the group of monovalent or polyvalent alcohols, alkanolamines or glycol ethers if they are miscible with water in the given concentration range. The solvents are preferably selected from ethanol, n-propanol or isopropanol, butanols, glycol, propanediol or butanediol, glycerol, diglycol, propyl diglycol or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether or propylene glycol propyl ether, dipropylene glycol monomethyl ether or dipropylene glycol monoethyl ether, diisopropylene glycol monomethyl ether or diisopropylene glycol monoethyl ether, methoxy triglycol, ethoxy triglycol or butoxy triglycol, 1-butoxyethoxy-2-propanol, 3-methyl-3-methoxybutanol, propylene glycol t-butyl ether, di-n-octyl ether as well as mixtures of these solvents. Nonaqueous solvents may be used in amounts between 0.5 and 15 wt %, but preferably less than 12 wt % and in particular less than 9 wt %, in the washing or cleaning composition.

To bring the pH of the washing or cleaning composition into the desired range, the use of pH adjusting agents may be indicated. All of the known acids and/or bases may be used here if their use is not prohibited for technical application reasons or ecological reasons or for reasons of consumer protection. The amount of this adjusting agent does not usually exceed 10 wt % of the total formulation.

The pH of the washing or cleaning composition is preferably between 4 and 10 and preferably between 5.5 and 8.8.

In a preferred embodiment, the washing or cleaning composition contains one or more perfumes in an amount of usually up to 10 wt %, preferably 0.01 to 5 wt %, in particular 0.3 to 3 wt %.

Individual perfume compounds may be used as perfume oils and/or scents, e.g., the synthetic products of the type of esters, ethers, aldehydes, ketones, alcohols and hydrocarbons. However, mixtures of different perfumes which jointly produce an appealing scent note are preferred. Such perfume oils may also contain natural perfume mixtures, such as those accessible from plant sources.

To improve the aesthetic impression of the washing or cleaning composition, they may be dyed with suitable dyestuffs. Preferred dyestuffs, a selection of which will not pose any problem for those skilled in the art, have a high stability in storage and are insensitive to the other ingredients of the textile treatment agents and to light and do not have any pronounced substantivity with respect to textile fibers, so they do not dye the latter.

Foam inhibitors which may be used in the washing or cleaning compositions include, for example, soaps, paraffins or silicone oils, which may optionally be applied to vehicle materials.

Suitable soil-release polymers, also known as “anti-redeposition agents,” include nonionic cellulose ethers such as methylcellulose and methylhydroxypropylcellulose, for example, with a methoxy group content of 15 to 30 wt % and hydroxypropyl groups of 1 to 15 wt %, each based on the nonionic cellulose ether as well as the polymers of phthalic acid and/or terephthalic acid and/or their derivatives known from the state of the art, in particular polymers of ethylene terephthalates and/or polyethylene glycol terephthalates and/or polypropylene glycol terephthalates or anionically and/or nonionically modified derivatives thereof. Suitable derivatives include the sulfonated derivatives of phthalic acid polymers and terephthalic acid polymers.

Graying inhibitors have the function of keeping the dirt released from the fiber suspended in the bath to thereby prevent the dirt from being redeposited. Water-soluble colloids, usually of an organic type, are suitable for this, e.g., glue, gelatins, salts of ether sulfonic acids of starch or cellulose or salts of acidic sulfuric acid esters of cellulose or starch. Water-soluble polyamides containing acid groups are also suitable for this purpose. In addition, soluble starch preparations and starch products other than those mentioned above may also be used, for example, degraded starch, aldehyde starches, etc. Polyvinylpyrrolidone may also be used. However, cellulose ethers such as carboxymethylcellulose (sodium salt), methylcellulose, hydroxyalkylcellulose and mixed ethers, such as methylhydroxyethylcellulose, methylhydroxypropylcellulose, methylcarboxymethylcellulose and mixtures thereof in amounts of 0.1 to 5 wt %, based on the total amount of washing or cleaning composition, are preferred for use.

Since textile fabrics, in particular rayon, cellulose, cotton and blends thereof tend to wrinkle because the individual fibers are sensitive to bending, kinking, pressing and squeezing across the direction of the fiber, the washing or cleaning compositions may contain synthetic wrinkle-resistant agents. These include, for example, synthetic products based on fatty acids, fatty acid esters, fatty acid amides, fatty alkylol esters, fatty alkylolamides or fatty alcohols, which are usually reacted with ethylene oxide, or products based on lecithin or modified phosphoric acid esters.

To combat microorganisms, the textile treatment agents may contain antimicrobial active ingredients. Depending on the antimicrobial spectrum and mechanism of action, a distinction is made here between bacteriostatics and bactericides, fungistatics and fungicides, etc. Important substances from these groups include, for example, benzalkonium chlorides, alkylarylsulfonates, halophenols and phenol mercuriacetate, but these compounds may also be omitted entirely from the inventive washing or cleaning compositions.

The inventive textile treatment agents may contain preservatives, whereby preferably only those having little or no skin sensitizing potential are used. Examples include sorbic acid and its salts, benzoic acid and its salts, salicylic acid and its salts, phenoxyethanol, formic acid and its salts, 3-iodo-2-propynylbutyl carbamate, sodium N-(hydroxymethyl) glycinate, biphenyl-2-ol and mixtures thereof. A suitable preservative is the solvent-free aqueous combination of diazolidinylurea, sodium benzoate and potassium sorbate (available as Euxyl® K 500 from Schuelke & Mayr), which may be used in a pH range of up to 7.

To prevent unwanted changes in the textile treatment agents or the textile fabrics treated with them due to the effects of oxygen and other oxidative processes, the washing or cleaning agents may contain antioxidants. This class of compounds includes, for example, substituted phenols, hydroquinones, pyrocatechols and aromatic amines as well as organic sulfides, polysulfides, dithiocarbamates, phosphites, phosphonates and vitamin E.

An increased wearing comfort may result from the additional use of antistatics which are additionally added to the washing or cleaning compositions. Antistatics increase the surface conductivity and thus allow improved dissipation of the charges thereby formed.

External antistatics are usually substances with at least one hydrophilic molecular ligand and they give a more or less hygroscopic film on surfaces. These antistatic agents, usually surfactants, can be subdivided into antistatics containing nitrogen (amines, amides, quaternary ammonium compounds), antistatics containing phosphorus (phosphoric acid esters) and antistatics containing sulfur (alkylsulfonates, alkyl sulfates). Lauryl (and/or stearyl) dimethylbenzylammonium chlorides are suitable as antistatics for textile fabrics and/or as an additive to textile treatment agents, additionally yielding a finish effect.

To improve the rewettability of the treated textile fabric and to facilitate ironing of the treated textile fabric, silicone derivatives, for example, may be used in the textile treatment agents. These additionally improve the rinsing behavior of the washing or cleaning composition due to their foam-inhibiting properties. Preferred silicone derivatives include, for example, polydialkyl- or alkylarylsiloxanes in which the alkyl groups have 1 to 5 carbon atoms and are partially or completely fluorinated. Preferred silicones are polydimethylsiloxanes, which may be derivatized, if necessary, and then are amino-functional or quaternated and/or have Si—OH bonds, Si—H bonds and/or Si—Cl bonds. The viscosities of the preferred silicones are in the range between 100 and 100,000 mPas at 25° C., whereby the silicones may be used in amounts between 0.2 and 5 wt %, based on the total amount of washing or cleaning composition.

Finally, the washing or cleaning composition may also contain UV absorbers, which are taken up onto the treated textile fabric and improve the photostability of the fibers. Compounds having these desired properties are, for example, the compounds and derivatives of benzophenone with substituents in positions 2 and/or 4 that are active due to radiationless deactivation. In addition, substituted benzotriazoles, acrylates with a phenyl substitution in position 3 (cinnamic acid derivatives), optionally with cyano groups in position 2, and salicylates, organic Ni complexes and natural substances such umbelliferone and endogenous urocanic acid are also suitable.

To avoid the decomposition of certain washing composition ingredients catalyzed by heavy metals, substances that complex heavy metals may be used. Suitable heavy metal complexing agents include, for example, the alkali salts of ethylenediaminetetraacetic acid (EDTA) or nitrilotriacetic acid (NTA), methylglycinediacetic acid trisodium salt (MGDA) and alkali metal salts of anionic polyelectrolytes, such as polymaleates and polysulfonates.

A preferred class of complexing agents includes the phosphonates which are present in the washing or cleaning compositions in amounts of 0.01 to 2.5 wt %, preferably 0.02 to 2 wt % and in particular 0.03 to 1.5 wt %. These preferred compounds include in particular organophosphonates, such as 1-hydroxyethane-1,1-diphosphonic acid (HEDP), aminotri(methylene-phosphonic acid) (ATP), diethylenetriaminepenta(methylenephosphonic acid) (DTPMP or DETPMP) as well as 2-phosphonobutane-1,2,4-tricarboxylic acid (PBS-AM), which are generally used in the form of their ammonium or alkali metal salts.

The inventive washing or cleaning compositions may be used for washing and/or cleaning textile fabrics, in particular dyed textile fabrics.

To produce the washing or cleaning composition, first a basic recipe is prepared by conventional and known methods and processes in which the ingredients of the basic recipe are simply mixed in stirred vessels, for example, whereupon water, nonaqueous solvents and surfactants are expediently placed there first and the other ingredients, fatty alkyl dialkylhydroxyethylammonium salt as dye transfer inhibitor are added in portions. Separate heating during production is not necessary; if it is desired, the temperature of the mixture should not exceed 80° C.

The compositions of two inventive washing or cleaning compositions E1 and E2 as well as that of a comparative example V1 are summarized in the following table.

TABLE 1

| | V1 | E1 | E2 | E3 |
|---|---|---|---|---|
| C₁₂₋₁₄ fatty alcohol with 7 EO | 10 | 10 | 10 | 10 |
| C₁₂₋₁₄ alkyl polyglycoside | 3 | 3 | 3 | 3 |
| Polyacrylate thickener | 0.2 | 0.2 | 0.2 | 0.2 |
| Ethanol | 3 | 3 | 3 | 3 |
| Citric acid | 5 | 5 | 5 | 5 |
| Phosphonic acid* | 0.4 | 0.4 | 0.4 | 0.4 |
| Fatty | — | 1 | 1 | 2 |
| alkyldialkylhydroxyethyl- | 0.1 | — | 0.1 | 0.2 |
| ammonium salt | | | | |
| PVP/PVI*** | 3.2 | 3.2 | 3.2 | 3.2 |
| Sodium hydroxide solution (50%) | 9 | 9 | 9 | 9 |
| Propylene glycol | 1 | 1 | 1 | 1 |
| Boric acid | 0.003 | 0.003 | 0.003 | 0.003 |
| Silicone foam suppressant | 1.5 | 1.5 | 1.5 | 1.5 |
| Perfume | + | + | + | + |
| Enzyme****, dyestuff | to 100 | to 100 | to 100 | to 100 |
| Water | | | | |

*Diethylenetriamine(pentamthylenephosphonic acid)
**C₁₂/C₁₄ fatty alkyl dimethylhydroxyethylammonium chloride (Praepagen ® HY, from Clariant)
***Sokalan ® HP 56 (from BASF)
****Mixture of cellulase, amylase and protease

All washing or cleaning compositions are stable and do not have any precipitates.

To determine the dye transfer inhibiting properties of the individual washing or cleaning compositions, a Staining Scale Rating (SSR), which is based on ISO 105A04, was performed. To do so, two white fabrics (so-called accompanying fabric, 6×16 cm each) together with a colored fabric (weight 0.3 g) were washed at 60° C. in a Lini-Tester (from Atlas) using one of the washing or cleaning compositions indicated above (dosage 5 g/L), then rinsed with water and dried hanging at room temperature. Next the degree of discoloration of the two accompanying fabrics was determined by spectrophotometry.

The colored fabrics were dyed either with Direct Orange 39 (cotton fabric), Direct Black 22 (cotton fabric), Direct Red 83:1 (cotton fabric) or Acid Blue 113 (polyamide fabric). The white fabrics used in one experiment were one white cotton fabric and one white polyamide [nylon] fabric. The colored fabric

The degree of discoloration was then given in values of 1 (heavy discoloration) to 5 (no discoloration).

TABLE 2
Discoloration of white cotton fabric

| Dye source | V1 | E1 | E2 | E3 |
|---|---|---|---|---|
| Direct Orange 39 | 2.5 | 4.0 | 4.0 | 4.0 |
| Direct Black 22 | 4.0 | 4.3 | 4.5 | 4.5 |
| Direct Red 83:1 | 4.7 | 3.1 | 3.2 | 4.7 |
| Acid Blue 113 | 4.9 | 4.9 | 4.9 | 5.0 |

TABLE 3
Discoloration of white polyamide fabric

| Dye source | V1 | E1 | E2 | E3 |
|---|---|---|---|---|
| Direct Orange 39 | 2.6 | 3.0 | 3.2 | 3.5 |
| Direct Black 22 | 3.2 | 2.9 | 2.8 | 3.2 |
| Direct Red 83:1 | 4.9 | 4.2 | 4.2 | 5.0 |
| Acid Blue 113 | 1.9 | 3.7 | 3.8 | 4.1 |

It is clear from the SSR that the inventive washing or cleaning compositions have improved dye transfer inhibiting properties in comparison with the reference recipe. An improvement is observed in particular with Acid Blue 113 with respect to polyamide fabric and with Direct Orange 39 with respect to cotton and polyamide fabric. The inventive washing or cleaning compositions therefore have very good dye transfer inhibiting properties with respect to several textile dyestuffs simultaneously.

Other than where otherwise indicated, or where required to distinguish over the prior art, all numbers expressing quantities of ingredients herein are to be understood as modified in all instances by the term “about”. As used herein, the words “may” and “may be” are to be interpreted in an open-ended, non-restrictive manner. At minimum, “may” and “may be” are to be interpreted as definitively including, but not limited to, the composition, structure, or act recited.

As used herein, and in particular as used herein to define the elements of the claims that follow, the articles “a” and “an” are synonymous and used interchangeably with “at least one” or “one or more,” disclosing or encompassing both the singular and the plural, unless specifically defined herein otherwise. The conjunction “or” is used herein in both in the conjunctive and disjunctive sense, such that phrases or terms conjoined by “or” disclose or encompass each phrase or term alone as well as any combination so conjoined, unless specifically defined herein otherwise.

The description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed. Steps in any method disclosed or claimed need not be performed in the order recited, except as otherwise specifically disclosed or claimed or as needed to render such methods operative.

Changes in form and substitution of equivalents are contemplated as circumstances may suggest or render expedient. Although specific terms have been employed herein, such terms are intended in a descriptive sense and not for purposes of limitation.

What is claimed:

1. A washing or cleaning composition comprising a surfactant and a dye transfer inhibitor comprising a fatty alkyl dialkylhydroxyethylammonium salt.

2. The composition of claim 1, comprising 0.001 to 10 wt % of the fatty alkyl dimethylhydroxyethylammonium salt.

3. The composition of claim 2, comprising 0.1 to 5 wt % of the fatty alkyl dimethylhydroxyethylammonium salt.

4. The composition of claim 1, wherein the dye transfer inhibitor comprises a fatty alkyl dimethylhydroxyethylammonium salt.

5. The composition of claim 4, wherein the dye transfer inhibitor comprises a C₁₂-C₁₄ fatty alkyl dimethylhydroxyethylammonium chloride.

6. The composition of claim 1, further comprising a second dye transfer inhibitor.

7. The composition of claim 6, wherein the second dye transfer inhibitor comprises one or more of polyvinylpyrrolidone, polyvinylimidazole, a copolymer of vinylpyrrolidone and vinylimidazole, polyvinylpyridine-N-oxide and poly-N-carboxymethyl-4-vinylpyridium chloride.

8. The composition of claim 1, comprising less than 5 wt % of anionic surfactants.

9. The composition of claim 1, wherein the surfactant consists of one or more nonanionic surfactants.

10. A method of washing or cleaning a dyed textile fabric, comprising the steps of:
providing a washing or cleaning composition comprising a surfactant and a dye transfer inhibitor comprising a fatty alkyl dialkylhydroxyethylammonium salt, and
contacting a dyed textile fabric in need of washing or cleaning with an effective amount of the washing or cleaning composition.

11. A method of inhibiting dye transfer in a washing or cleaning process, comprising the steps of
providing a dyed textile fabric in need of washing or cleaning,
contacting the dyed textile fabric with an aqueous washing or cleaning solution, and
providing the washing or cleaning solution in contact with the dyed textile fabric with an amount of a fatty alkyl dialkylhydroxyethylammonium salt effective to inhibit dye transfer from the dyed textile fabric.

12. A method of producing a washing or cleaning agent, comprising combining a surfactant and a dye transfer inhibitor comprising a fatty alkyl dialkylhydroxyethylammonium salt.
